(19) United States
(12) Patent Application Publication
(10) Pub. No.: US 2024/0279545 A1
(43) Pub. Date: Aug. 22, 2024

(54) FLUORESCENCE TEMPERATURE MEASUREMENT MATERIAL, PREPARATION METHOD THEREFOR, AND USE THEREOF

(71) Applicant: WUYI UNIVERSITY, Jiangmen (CN)

(72) Inventors: Yan GAO, Jiangmen (CN); Yan CUI, Jiangmen (CN); Jian SONG, Jiangmen (CN); Zhichao MENG, Jiangmen (CN); Tao HU, Jiangmen (CN)

(21) Appl. No.: 18/570,262

(22) PCT Filed: May 24, 2022
(86) PCT No.: PCT/CN2022/094635

§ 371 Date: Dec. 14, 2023

(30) Foreign Application Priority Data
May 18, 2022 (CN) 202210542168.X

(51) Int. Cl. C09K 11/77; G01K 11/20; G01K 15/00

(52) U.S. Cl. CPC C09K 11/7703; G01K 11/20; G01K 15/002; G01K 15/005

(57) ABSTRACT

A fluorescence temperature measurement material, a preparation method therefore and use thereof are disclosed, which belong to the technical field of fluorescence temperature sensing. The fluorescence temperature measurement material has a chemical composition of Na₁₋ₓSrₓTaO₃:yPr³⁺, x=0.1-0.2 and y=0.4%-0.6%. The fluorescence temperature measurement material is prepared by a high-temperature solid-phase method and generates blue light at 492 nm (³P₀→³H₄) and red light at 610 nm (¹D₂→³H₄) under the excitation of 290 nm ultraviolet light. The fluorescence intensity ratio (¹D₂→³H₄/³P₀→³H₄) of two emission peaks has an exponential function relationship with temperature, so that the fluorescence temperature measurement material can calibrate temperature and has good temperature-sensitive performance. Moreover, the fluorescence temperature measurement material has a particle size of <1 μm, a good spatial resolution and a significant CIE color coordinate change along with temperature.

### CROSS-REFERENCE TO RELATED APPLICATIONS

The present application is a national phase entry under 35 USC § 371 of International Application PCT/CN2022/094635 filed May 24, 2022, which claims the benefit of and priority to Chinese Patent Application 202210542168.X, filed May 18, 2022, the entire disclosures of which are incorporated herein by reference.

### TECHNICAL FIELD

The present disclosure belongs to the technical field of fluorescence temperature sensing, and specifically relates to a fluorescence temperature measurement material, a preparation method therefor, and use thereof.

### BACKGROUND

Temperature measurement is closely related to people's daily life, and plays a vital role in medicine, chemistry, military technology, and life and production. Nowadays, with the rapid development of science, technology and medical protection, people have put forward higher requirements on the accuracy of temperature measurement instrument and the applicable range of the temperature measurement instrument, however, traditional contact thermometers such as a glass thermometer, a thermocouple, and a thermistor are difficult to meet the new requirements.

The fluorescence temperature sensing technology is considered as a promising optical temperature measurement technology due to the characteristics of higher response speed, higher spatial resolution, non-contact type and the like. The fluorescence intensity ratio (FIR) temperature measurement technology, which achieves temperature detection by using a law that the intensity of two emission peaks of a luminescent material changes with temperature, is not affected by the surrounding environment, has low requirements on the temperature detection environment, has the advantages of fast response, high spatial resolution, self-calibration, and high sensitivity, and thus have a broader application prospect.

Most of reported FIR fluorescence thermometers measure the temperature by using the fluorescence intensity ratio of two thermally coupled energy levels of lanthanide ions such as Er³⁺, Tm³⁺, and Ho³⁺. The band gaps of the thermal coupling energy levels of these ions are small, which is not conducive to the discrimination of optical signals and limits the further improvement of the temperature measurement sensitivity. Therefore, the preparation of a fluorescence temperature measurement material with better optical signal discrimination and higher sensitivity is a technical problem to be solved at present.

### SUMMARY

An objective of the present disclosure is to overcome the above problems in the prior art and provide a fluorescence temperature measurement material, a preparation method therefor, and use thereof.

The present disclosure is implemented by the following technical solutions.

The present disclosure provides a fluorescence temperature measurement material, which has a chemical composition of Na₁₋ₓSrₓTaO₃:yPr³⁺, wherein x=0.1-0.2, and y=0.4%-0.6%.

According to the present disclosure, Pr³⁺ ions are doped into an orthorhombic perovskite Na₁₋ₓSrₓTaO₃ (x=0.1-0.2) solid solution, an energy level difference between ³P₀ energy level and ¹D₂ energy level of the Pr³⁺ ions is about 3500 cm⁻¹, and emission peak positions of the ³P₀ energy level and ¹D₂ energy level are respectively positioned in a blue light wave band (³P₀→³H₄) and a red light wave band (¹D₂→³H₄), therefore, Pr³⁺ ions have good optical signal discrimination. According to the present disclosure, Pr³⁺ ions are doped into the orthorhombic perovskite, so that the prepared fluorescence temperature measurement material has ultrahigh temperature measurement sensitivity.

As a preferred embodiment of the fluorescence temperature measurement material according to the present disclosure, x=0.15 and y=0.5%.

Another objective of the present disclosure is to provide a preparation method for the fluorescence temperature measurement material, which comprises the following steps: weighing raw materials based on the chemical composition, uniformly mixing, adding a solvent, grinding, pre-sintering, regrinding and calcining to obtain the fluorescence temperature measurement material.

As a preferred embodiment of the preparation method for the fluorescence temperature measurement material according to the present disclosure, the raw materials comprise Na₂CO₃, SrCO₃, Ta₂O₅, and Pr₆O₁₁.

As a preferred embodiment of the preparation method for the fluorescence temperature measurement material according to the present disclosure, the solvent is anhydrous ethanol, and the grinding is performed for 20-40 min, preferably 30 min.

As a preferred embodiment of the preparation method for the fluorescence temperature measurement material according to the present disclosure, the pre-sintering is performed at a temperature of 300-500° C. for 1-3 h, and preferably, the pre-sintering is performed at a temperature of 400° C. for 2 h.

As a preferred embodiment of the preparation method for the fluorescence temperature measurement material according to the present disclosure, the regrinding is performed for 10-20 min, preferably 15 min.

As a preferred embodiment of the preparation method for the fluorescence temperature measurement material according to the present disclosure, the calcining is performed at a temperature of 900-1050° C. for 6-10 h, and preferably, the calcining is performed for 8 h.

Yet another objective of the present disclosure is to provide a use of the fluorescence temperature measurement material and the preparation method therefor in temperature sensing.

As a preferred embodiment of the use of the fluorescence temperature measurement material according to the present disclosure, a calibration temperature is a ratio of an emission peak intensity of the fluorescence temperature measurement material at 492 nm and the emission peak intensity of the fluorescence temperature measurement material at 610 nm obtained by exciting the fluorescence temperature measurement material with an ultraviolet light with a wavelength of 290 nm.

The beneficial effects of the present disclosure are as follows.
(1) The fluorescence temperature measurement material of the present disclosure generates emission peaks at 492 nm and 610 nm under the excitation of 290 nm ultraviolet light, the emission peaks at 492 nm and 610 nm correspond to ³P₀→³H₄ and ¹D₂→³H₄ radiative transitions of Pr³⁺. In a range of 303 K to 483 K, a fluorescence intensity ratio (¹D₂→³H₄/³P₀→³H₄) of the material has an exponential function relationship with temperature, and can be used to calibrate the temperature. Since one of the two emission peaks is positioned at a blue light wave band (492 nm), and the other emission peak is positioned at a red light wave band (610 nm), the fluorescence temperature measurement material prepared has an excellent signal discrimination.
(2) The fluorescence temperature measurement material of the present disclosure has a particle size of less than 1 μm, such that it has a better spatial resolution. Moreover, the CIE coordinate of the fluorescence temperature measurement material changes significantly with temperature, so the fluorescence temperature measurement material of the present application has ultrahigh sensitivity and signal resolution, and thus has great application potential in the field of optical temperature measurement.

### BRIEF DESCRIPTION OF DRAWINGS

FIG. 1 is an XRD pattern of fluorescence temperature measurement materials according to Examples 1-3;

FIG. 2 is an emission spectrum (λₑₓ=290 nm) at room temperature of the fluorescence temperature measurement materials according to Examples 1-3;

FIG. 3 is an SEM image of the fluorescence temperature measurement materials according to Example 1;

FIG. 4 is a temperature-dependent spectrum (303 K to 483 K) of the fluorescence temperature measurement material according to Example 1 with an excitation wavelength of 290 nm;

FIG. 5A is an intensity (303 K to 483 K) of an emission peak at 492 nm (blue) of the fluorescence temperature measurement material according to Example 1, and FIG. 5B is an intensity (303 K to 483 K) of an emission peak at 610 nm (red) of the fluorescence temperature measurement material according to Example 1;

FIG. 6 is a fitted plot of a fluorescence intensity ratio (¹D₂→³H₄/³P₀→³H₄) of the fluorescence temperature measurement material according to Example 1;

FIG. 7 is a CIE color coordinate of the fluorescence temperature measurement material according to Example 1 in a range of 303 K to 483 K;

FIG. 8 is a curve of an absolute sensitivity Sa and a relative sensitivity Sᵣ of the fluorescence temperature measurement material according to Example 1;

FIG. 9 is a temperature-dependent spectrum (303 K to 483 K) of the fluorescence temperature measurement material according to Example 2 with an excitation wavelength of 290 nm;

FIG. 10 is a temperature-dependent spectrum (303 K to 483 K) of the fluorescence temperature measurement material according to Example 3 with an excitation wavelength of 290 nm;

FIG. 11A is an XRD pattern of the fluorescence temperature measurement material according to Comparative Example 1, and FIG. 11B is an emission spectrum (λₑₓ=290 nm) at room temperature of the fluorescence temperature measurement material according to Comparative Example 1;

FIG. 12 is a temperature-dependent spectrum (303 K to 483 K) of the fluorescence temperature measurement material according to Comparative Example 1 with an excitation wavelength of 290 nm;

FIG. 13A is an XRD pattern of the fluorescence temperature measurement material according to Comparative Example 2, and FIG. 13B is an emission spectrum (λₑₓ=290 nm) at room temperature of the fluorescence temperature measurement material according to Comparative Example 2; and

FIG. 14 is a temperature-dependent spectrum (303 K to 483 K) of the fluorescence temperature measurement material according to Comparative Example 2 with an excitation wavelength of 290 nm.

### DETAILED DESCRIPTION

To better illustrate the objectives, technical solutions, and advantages of the present disclosure, the present disclosure will be further described below with reference to specific examples. Those skilled in the art should understand that the specific examples described herein are merely illustrative of the present disclosure and do not limit the protection scope of the present disclosure.

Unless otherwise stated, the test methods used in the following examples are conventional methods. The materials, reagents, and the like used in the following examples can be commercially available unless otherwise stated. The material of the present disclosure is used for non-contact temperature measurement.

### Example 1

0.3 mmol of SrCO₃, 0.85 mmol of Na₂CO₃, 1 mmol of Ta₂O₅, and 0.00167 mmol of Pr₆O₁₁ were uniformly mixed, 5 mL of anhydrous ethanol was added, a resulting mixture was ground in an agate mortar for 30 min, and the grinded mixture was filled into a corundum crucible and then put into a muffle furnace for pre-sintering for 2 h at 400° C. After the sample was cooled, the sample was placed in a mortar to be ground for 15 min at a constant speed. The reground powder was loaded into a crucible and calcined in a muffle furnace at 1000° C. for 8 h, and finally the cooled sample was reground to uniform particles to obtain a Na_{0.85}Sr_{0.15}TaO₃:0.5% Pr³⁺ material.

### Example 2

0.2 mmol of SrCO₃, 0.9 mmol of Na₂CO₃, 1 mmol of Ta₂O₅, and 0.00167 mmol of Pr₆O₁₁ were uniformly mixed, 5 mL of anhydrous ethanol was added, a resulting mixture was ground in an agate mortar for 30 min, and the grinded mixture was filled into a corundum crucible and then put into a muffle furnace for pre-sintering for 2 h at 400° C. After the sample was cooled, the sample was placed in a mortar to be ground for 15 min at a constant speed. The reground powder was loaded into a crucible and calcined in a muffle furnace at 1000° C. for 8 h, and finally the cooled sample was reground to uniform particles to obtain a Na_{0.9}Sr_{0.1}TaO₃:0.5% Pr³⁺ material.

### Example 3

0.4 mmol of SrCO₃, 0.8 mmol of Na₂CO₃, 1 mmol of Ta₂O₅, and 0.00167 mmol of Pr₆O₁₁ were uniformly mixed, 5 mL of anhydrous ethanol was added, a resulting mixture was ground in an agate mortar for 30 min, and the grinded mixture was filled into a corundum crucible and then put into a muffle furnace for pre-sintering for 2 h at 400° C. After the sample was cooled, the sample was placed in a mortar to be ground for 15 min at a constant speed. The reground powder was loaded into a crucible and calcined in a muffle furnace at 1000° C. for 8 h, and finally the cooled sample was reground to uniform particles to obtain a Na_{0.8}Sr_{0.2}TaO₃:0.5% Pr³⁺ material.

### Comparative Example 1

0.1 mmol of SrCO₃, 0.95 mmol of Na₂CO₃, 1 mmol of Ta₂O₅, and 0.00167 mmol of Pr₆O₁₁ were uniformly mixed, 5 mL of anhydrous ethanol was added, a resulting mixture was ground in an agate mortar for 30 min, and the grinded mixture was filled into a corundum crucible and then put into a muffle furnace for pre-sintering for 2 h at 400° C. After the sample was cooled, the sample was placed in a mortar to be ground for 15 min at a constant speed. The reground powder was loaded into a crucible and calcined in a muffle furnace at 1000° C. for 8 h, and finally the cooled sample was reground to uniform particles to obtain a Na_{0.95}Sr_{0.05}TaO₃:0.5% Pr³⁺ material.

### Comparative Example 2

0.6 mmol of SrCO₃, 0.7 mmol of Na₂CO₃, 1 mmol of Ta₂O₅, and 0.00167 mmol of Pr₆O₁₁ were uniformly mixed, 5 mL of anhydrous ethanol was added, a resulting mixture was ground in an agate mortar for 30 min, and the grinded mixture was filled into a corundum crucible and then put into a muffle furnace for pre-sintering for 2 h at 400° C. After the sample was cooled, the sample was placed in a mortar to be ground for 15 min at a constant speed. The reground powder was loaded into a crucible and calcined in a muffle furnace at 1000° C. for 8 h, and finally the cooled sample was reground to uniform particles to obtain a Na_{0.7}Sr_{0.3}TaO₃:0.5% Pr³⁺ material.

### Example of Use

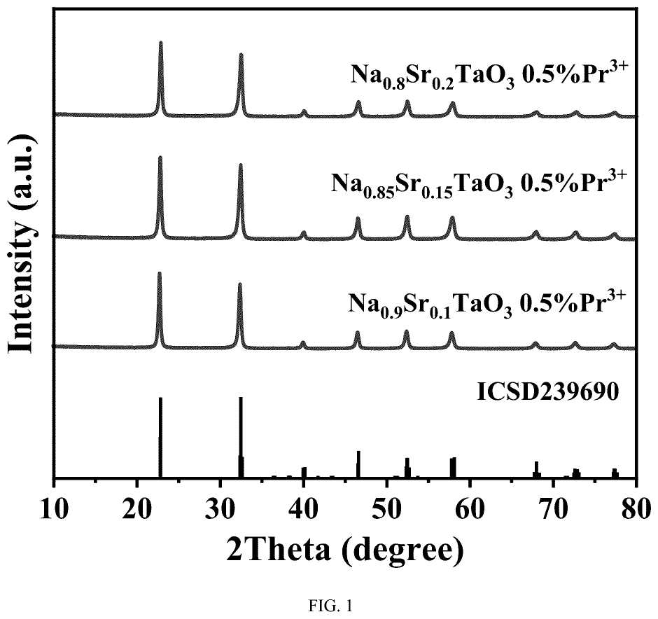

The XRD patterns of the fluorescence temperature measurement materials according to Examples 1-3 were measured by an X-ray diffractometer, the results were shown in FIG. 1, and it can be seen that the crystal structure of orthorhombic perovskite was not affected by the doping of 0.5% Pr³⁺.

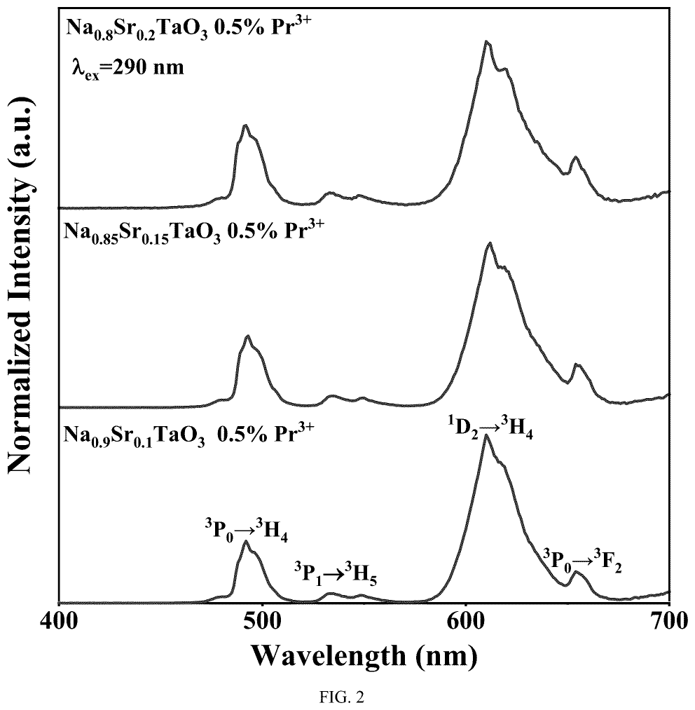

The emission spectra (λₑₓ=290 nm) at room temperature of the fluorescence temperature measurement materials according to Examples 1-3 were measured by a fluorescence spectrometer, and the results were shown in FIG. 2, As can be seen from FIG. 2, under the excitation of ultraviolet light at 290 nm, the Na_{0.85}Sr_{0.15}TaO₃:0.5% Pr³⁺ material of Example 1, the Na_{0.9}Sr_{0.1}TaO₃:0.5% Pr³⁺ material al of Example 2, and the Na_{0.8}Sr_{0.2}TaO₃:0.5% Pr³⁺ material of Example 3 all exhibited two strong main emission peaks at 492 nm and 610 nm, respectively, which were corresponding to ³P₀→³H₄ and ¹D₂→³H₄ transitions.

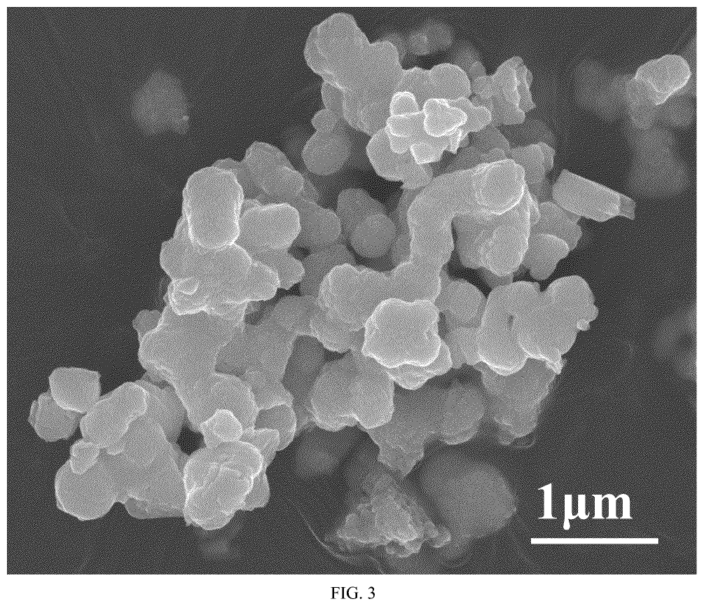

The SEM image of the fluorescence temperature measurement material according to Example 1 was detected by a scanning electron microscope, and the result was shown in FIG. 3. As can be seen from FIG. 3, the Na_{0.85}Sr_{0.15}TaO₃:0.5% Pr³⁺ fluorescence temperature measurement material prepared in Example 1 had a particle size of less than 1 μm, which had a good spatial resolution.

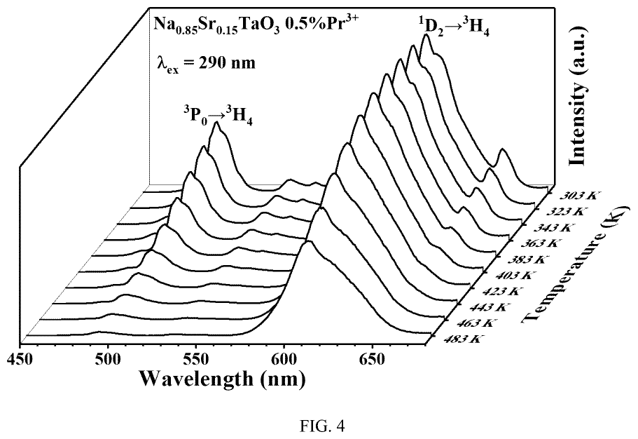

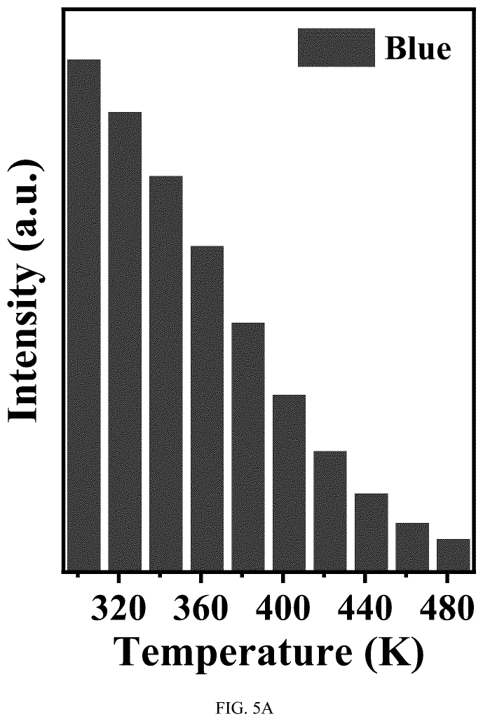

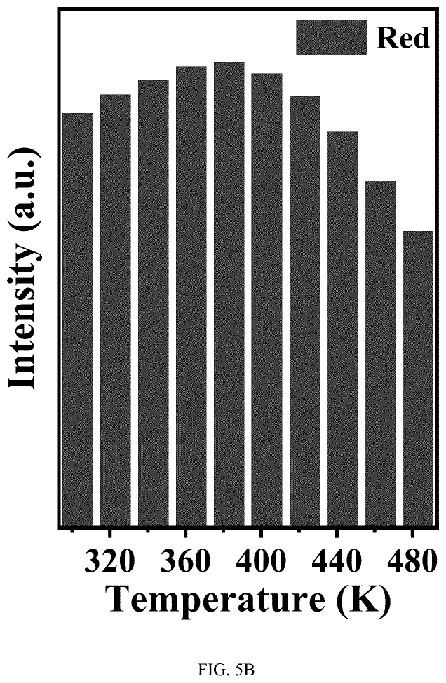

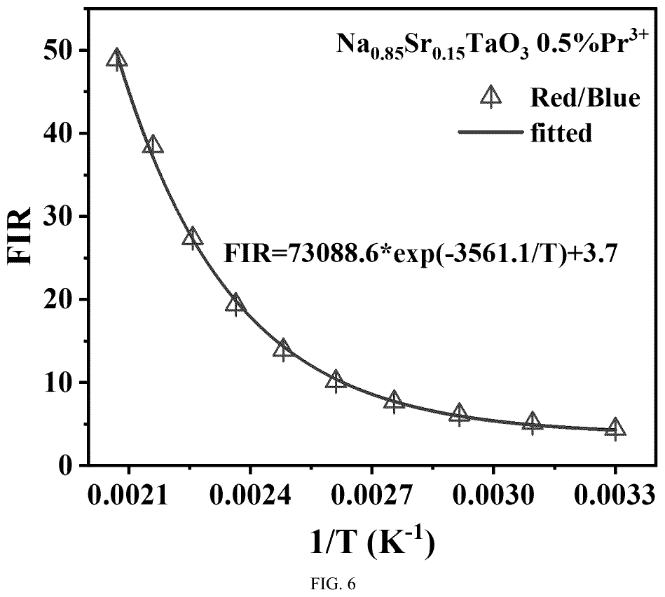

The temperature-dependent spectrum test was performed on the fluorescence temperature measurement material according to Example 1 by using an FLS980 fluorescence spectrometer, FIG. 4 was a temperature change spectrum (303 K to 483 K) of the material according to Example 1, and it can be seen from FIG. 4 that the Na_{0.85}Sr_{0.15}TaO₃:0.5% Pr³⁺ material in Example 1 had two strong main emission peaks at 492 nm and 610 nm in the range of 303 K to 483 K, which indicated that the material in Example 1 had better temperature sensing performance in the range of 303 K to 483 K; FIG. 5A was an intensity (303 K to 483 K) of an emission peak at 492 nm (blue) of the fluorescence temperature measurement material according to Example 1, FIG. 5B was an intensity (303 K to 483 K) of an emission peak at 610 nm (red) of the fluorescence temperature measurement material according to Example 1, as shown in FIG. 5A, the emission peak intensity I₄₉₂ (integrated intensity between 480 nm and 510 nm) at 492 nm (³P₀→³H₄) decreased significantly as the temperature increases from 303 K to 483 K, while the emission peak intensity I₆₁₀ (integrated intensity between 585 nm and 638 nm) at 610 nm (¹D₂→³H₄) increased first and then decreased (as shown in FIG. 5B), and the fluorescence intensity ratio I₆₁₀/I₄₉₂ (¹D₂→³H₄/³P₀→³H₄) had a certain exponential function relationship with the temperature; and FIG. 6 was a fitted plot of the fluorescence intensity ratio (¹D₂₊₃H₄/³P₀→³H₄) of the fluorescence temperature measurement material according to Example 1. The temperature of a to-be-measured object can be obtained by calculating the ratio I₆₁₀/I₄₉₂ of the emission peak intensity at 492 nm to the emission peak intensity at 610 nm and then comparing this ratio in an exponential function graph.

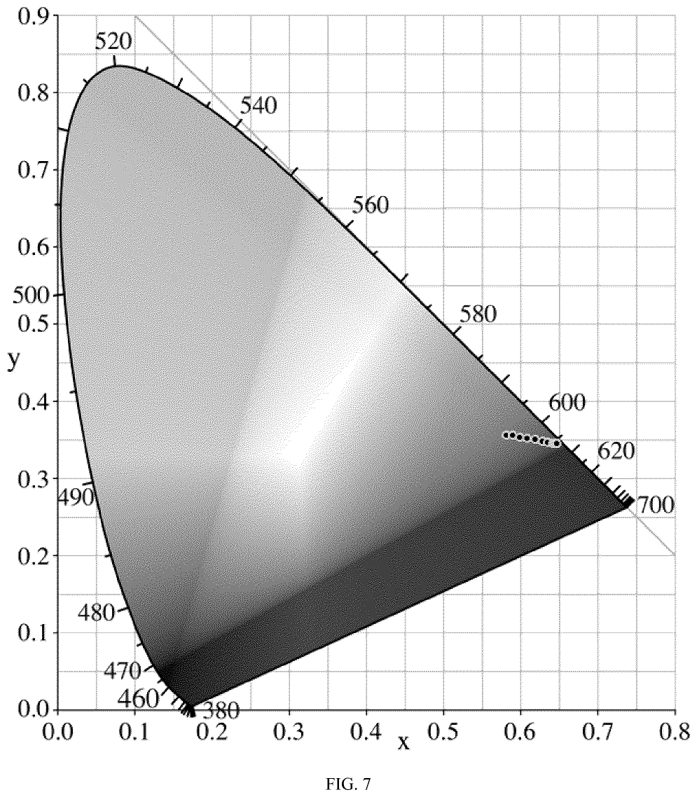

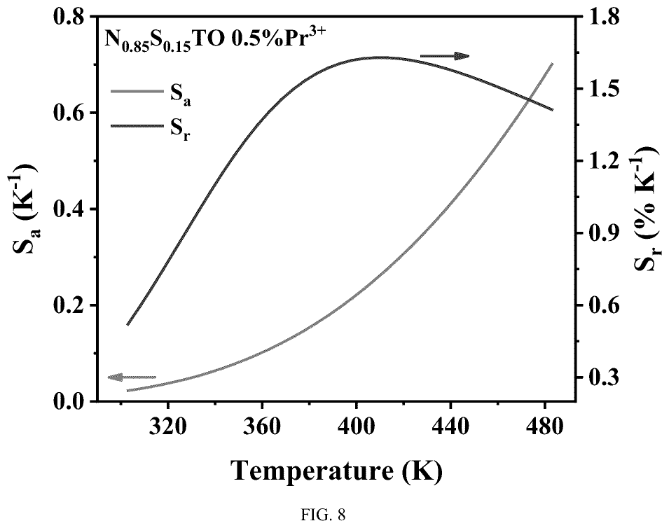

FIG. 7 was a CIE color coordinate of the fluorescence temperature measurement material according to Example 1 in a range of 303 K to 483 K, in which the CIE color coordinates changed significantly with the increase of temperature, which indicated that the temperature can be determined by the change of the luminescence color of the sample. FIG. 8 was a curve of an absolute sensitivity Sa and a relative sensitivity Sᵣ of the fluorescence temperature measurement material according to Example 1, which indicated that the material had an ultrahigh temperature measurement sensitivity.

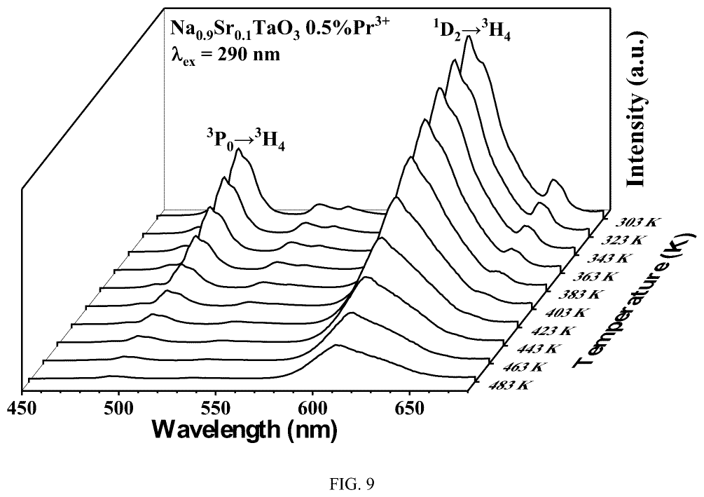

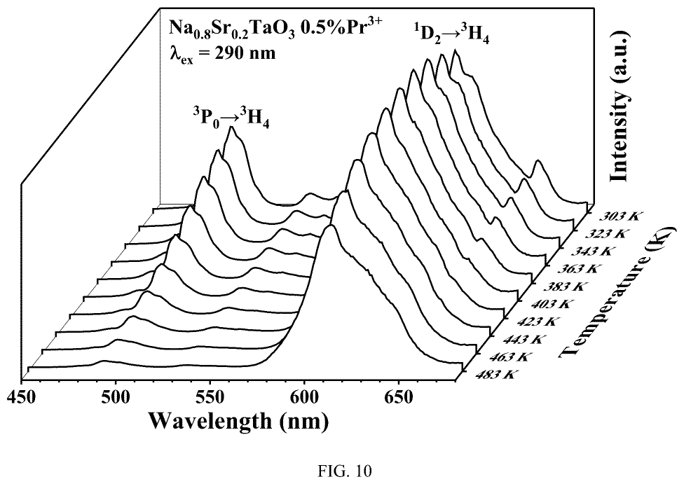

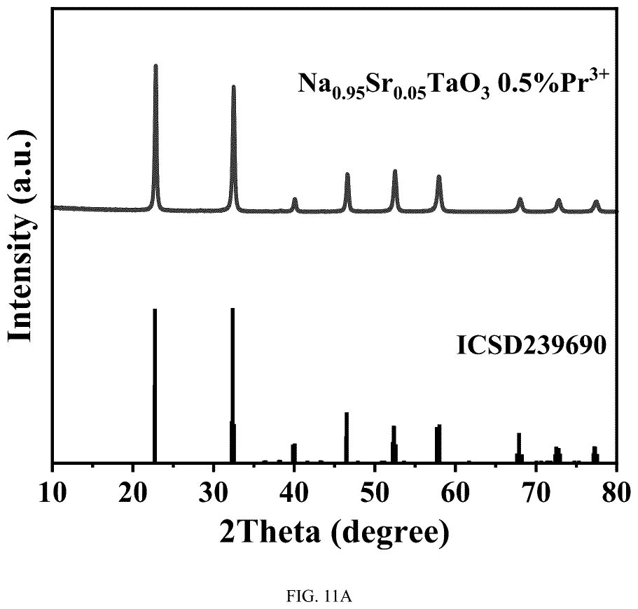

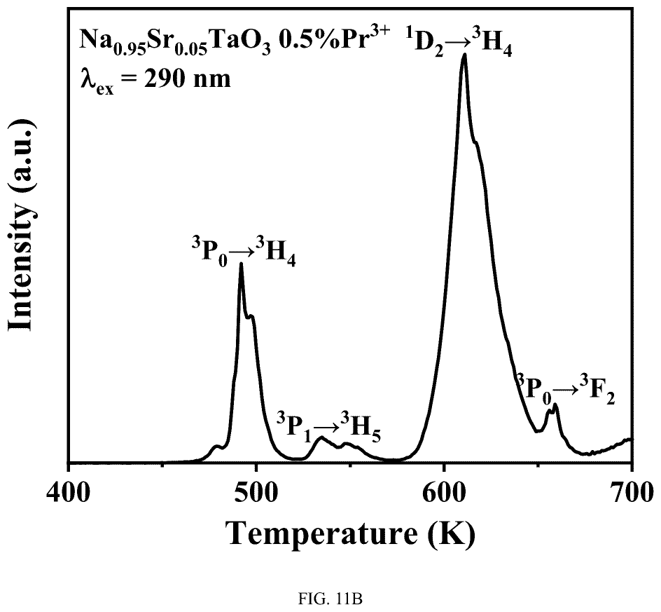

FIG. 9 was a temperature-dependent spectrum of the fluorescence temperature measurement material according to Example 2, and FIG. 10 was a temperature-dependent spectrum of the fluorescence temperature measurement material according to Example 3, with an excitation wavelength of 290 nm. It can be seen from FIGS. 9 and 10, the Na_{0.9}Sr_{0.1}TaO₃:0.5% Pr³⁺ material in Example 2 and the Na_{0.8}Sr_{0.2}TaO₃:0.5% Pr³⁺ material in Example 3 both had two strong emission main peaks at 492 nm and 610 nm in the range of 303 K to 483 K, and the fluorescence intensity ratio I₆₁₀/I₄₉₂ (¹D₂→³H₄/³P₀→³H₄) had a certain exponential function relationship with temperature, and therefore, the above materials can be used as temperature measurement materials.

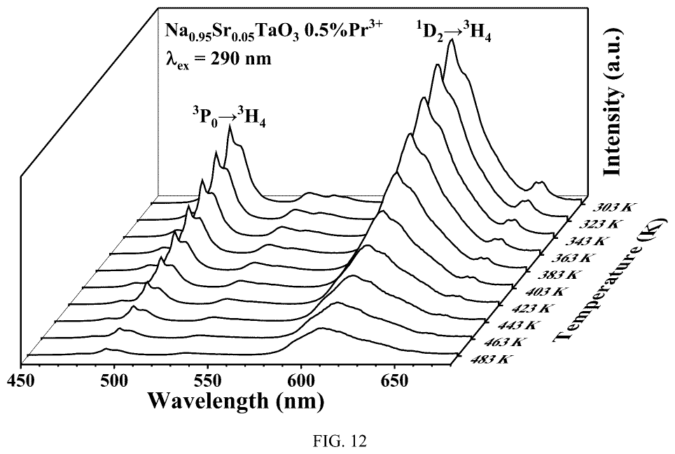

FIG. 11A was an XRD pattern of the fluorescence temperature measurement material according to Comparative Example 1, and FIG. 11B was an emission spectrum (λₑₓ=290 nm) at room temperature of the fluorescence temperature measurement material according to Comparative Example 1; FIG. 12 was a temperature-dependent spectrum (303 K to 483 K) of the fluorescence temperature measurement material according to Comparative Example 1 with an excitation wavelength of 290 nm; it can be seen from FIG. 12 that the emission peak intensity at 492 nm and the emission peak intensity at 610 nm of the fluorescence temperature measurement material according to Comparative Example 1 both significantly decreased as the temperature increases, in this case, the 610 nm emission peak cannot be used as a reference signal, indicating that the Na_{0.95}Sr_{0.05}TaO₃:0.5% Pr³⁺ material in Comparative Example 1 was not advantageous for use as a proportional temperature sensing material.

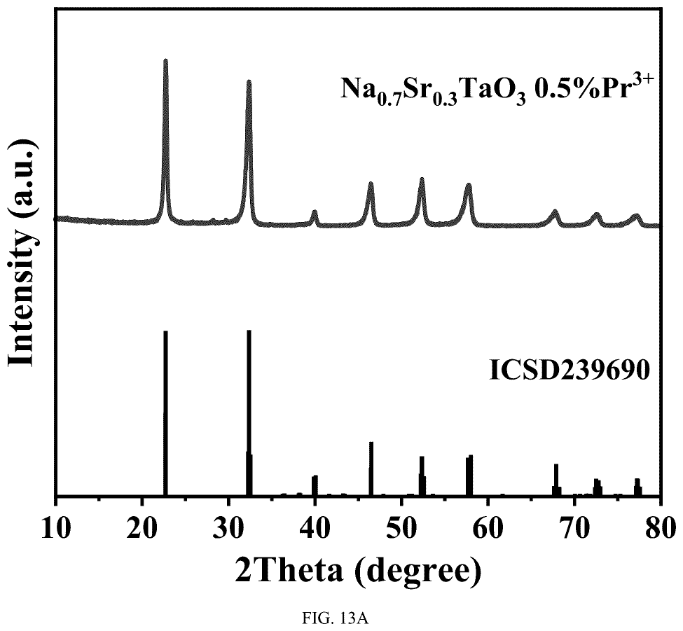

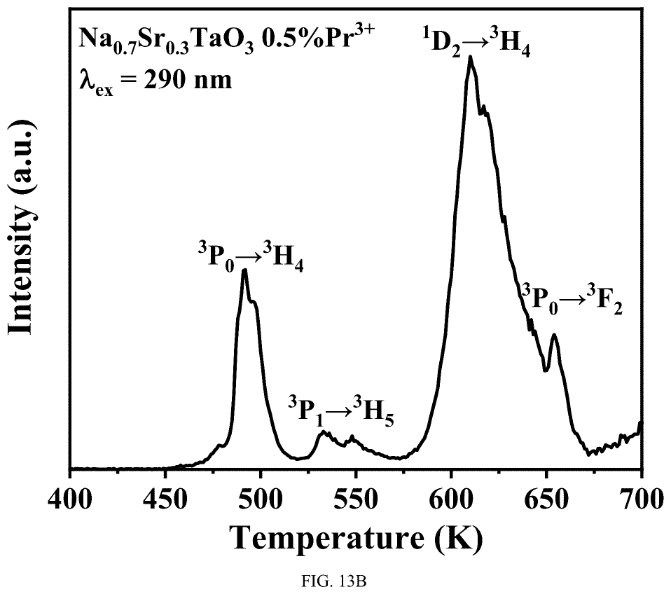

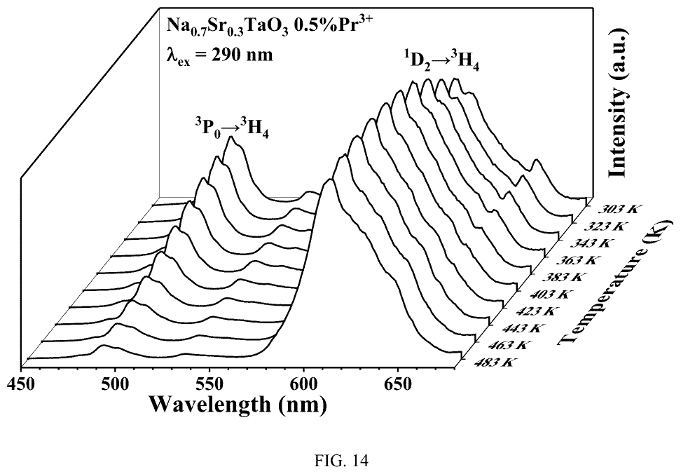

FIG. 13A was an XRD pattern of the fluorescence temperature measurement material according to Comparative Example 2, and FIG. 13B was an emission spectrum (λₑₓ=290 nm) at room temperature of the fluorescence temperature measurement material according to Comparative Example 2; FIG. 14 was a temperature-dependent spectrum (303 K to 483 K) of the fluorescence temperature measurement material according to Comparative Example 2 with an excitation wavelength of 290 nm; it can be seen from FIG. 14 that the Na_{0.7}Sr_{0.3}TaO₃:0.5% Pr³⁺ material in Comparative Example 2 showed a slow decrease in emission peak intensity at 492 nm as the temperature increases, which was not conducive to monitoring signals as a temperature probe.

Finally, it should be noted that the foregoing examples are merely intended for illustrating the technical solutions of the present disclosure and do not limit the protection scope of the present disclosure. Although the present disclosure is described in detail with reference to the preferred examples, those of ordinary skill in the art understand that the technical solutions of the present disclosure can be modified or equivalently substituted without departing from the essence and scope of the technical solutions of the present disclosure.

1. A fluorescence temperature measurement material, having a chemical composition of Na₁₋ₓSrₓTaO₃:yPr³⁺, wherein x=0.1-0.2, and y=0.4%-0.6%.

2. The fluorescence temperature measurement material according to claim 1, wherein x=0.15 and y=0.5%.

3. A preparation method for the fluorescence temperature measurement material according to claim 1, comprising the following steps:
weighing raw materials based on the chemical composition, uniformly mixing, adding a solvent, grinding, pre-sintering, regrinding, and calcining to obtain the fluorescence temperature measurement material.

4. The preparation method for the fluorescence temperature measurement material according to claim 3, wherein the raw materials comprise Na₂CO₃, SrCO₃, Ta₂O₅, and Pr₆O₁₁.

5. The preparation method for the fluorescence temperature measurement material according to claim 3, wherein the grinding is performed for 20-40 min.

6. The preparation method for the fluorescence temperature measurement material according to claim 3, wherein the pre-sintering is performed at a temperature of 300-500° C. for 1-3 h.

7. The preparation method for the fluorescence temperature measurement material according to claim 3, wherein the regrinding is performed for 10-20 min.

8. The preparation method for the fluorescence temperature measurement material according to claim 3, wherein the calcining is performed at a temperature of 900-1050° C. for 6-10 h.

9-10. (canceled)

11. A temperature sensor, comprising the fluorescence temperature measurement material according to claim 1.

12. A method for calibrating temperature, wherein the method comprises the steps of exciting the fluorescence temperature measurement material according to claim 1 with an ultraviolet light with a wavelength of 290 nm, and measuring the ratio of an emission peak intensity of the fluorescence temperature measurement material at 492 nm to the emission peak intensity of the fluorescence temperature measurement material at 610 nm.
